(19) United States
(12) Patent Application Publication
(10) Pub. No.: US 2011/0283842 A1
(43) Pub. Date: Nov. 24, 2011

(54) Screwdriver bit structure

(75) Inventor: Ying-Tsung Lai, Taichung (TW)

(73) Assignee: ROTE MATE INDUSTRY CO., LTD.

(21) Appl. No.: 12/801,092

(22) Filed: May 21, 2010

(51) Int. Cl. B25B 23/00

(52) U.S. Cl. 81/460; 81/436

(57) ABSTRACT

A screwdriver bit structure sequentially comprises a connection section, a neck reducing section and a driving section. A plurality of arc grooves is circularly disposed to a front of the driving section to form an operating end capable of embedding with a locking member. An effective working section is disposed to a front of the operating end, the characterized in that a reinforcement section is preset between an end of each arc groove of the driving section and a relative bottom edge of the driving section. An external diameter of a maximum cross-section of the effective working section is greater than a length of the neck reducing section. An external diameter of the neck reducing section is greater than or equal to a length of the working section. An upper tapering transition is disposed between the neck reducing section and the driving section.

### FIELD OF THE INVENTION

The present invention relates to a screwdriver bit structure, and more particularly to a screwdriver bit structure capable of improving structural strength and reducing the operation loss.

### BACKGROUND OF THE INVENTION

In the industrial technology field, a locking member, such as screws, is frequently utilized for connection between articles. To deal with different sizes of the screw locking members and the screw locking members having different embedding grooves, replaceable screwdriver bits with different types and various sizes are developed to provide operators to perform the replacement in accordance with demands.

A conventional screwdriver bit structure has a connection section and a driving section. The connection section is a polygonal cylinder that is fit to a screwdriver bar or an electric tool to perform the twist. The driving section is a post. A diameter of the driving section is smaller than an inner/tangency-diameter of the connection section. A plurality of arc grooves is circularly disposed to a front along an axis direction to design operating ends with different types. The foregoing operating ends include slotted screwdrivers, Phillips screwdrivers, pozidrive screwdrivers, . . . and so forth and are provided for firmly embedding in embedding grooves of the locking member to rotate the locking member into an article to be assembled.

The screwdriver bit may receive a torsion shearing stress while performing a twist operation. The computation of the torsion shearing stress is that a torsion value multiplies by a cross-section radius. The calculated result then divides by polar moment of inertia. Accordingly, the polar moment of inertia borne by the minimum cross-section radius of the screwdriver is the maximum. Relatively, the torsion shearing stress is the maximum as well. When the locking member driven by the screwdriver bit is rotated to a tightening state by incorporating an electric tool with high rotational speed, the operating ends in fronts of the screwdriver bit may be damaged by torsion or cracked after reaching a yield point.

To overcome the forgoing defect, Taiwan Patent Number: M358701, as entitled, “Screwdriver bit having damage prevention” comprises a combination portion and an operating portion, wherein the operating portion includes a driving end and a transition section. The transition section is provided with a first neck portion engaged with the driving end, a second neck portion engaged with the combination portion, and a buffer portion located between the first neck portion and the second neck portion. A diameter of the buffer portion is smaller than the first neck portion and the second neck portion. The diameter of the transition section is gradually reduced from the first neck portion to the buffer portion and then is gradually increased from the buffer portion to the second neck portion to form an arc recess shape, thereby extending the deformation time with respect to the force receiving and providing the alarm efficacy.

The foregoing structure is that the transition section is designed between the combination portion and the operating portion. The diameter of the transition section is gradually reduced and toward the middle portion of the transition section. The goal of the design is that a torsion shearing stress carried by the screwdriver bit is conducted to the transition section from the operating portion to allow the transition section to produce the deformation as much as possible, thereby extending the deformation time for the entire structure.

U.S. Pat. No. 5,868,047, as entitled, “Powered screwdriver bit structure” comprises a shank end, a tip end and a middle portion connected between the shank end and the tip end. A diameter of the middle portion is smaller than the shank end and the tip end. A length of the middle portion is from 18 mm to 23.5 mm, and a diameter of the middle portion is about 3.55 mm to 6.35 mm.

The forgoing conventional structures have defects. After the torsion shearing stress carried by the screwdriver bit reaches a yield point, the screwdriver bit may be finally cracked due to the shape of the screwdriver bit if the screwdriver bit is continuously forced. The screwdriver bit driven by an electric tool with high rotational speed and high torque is unable to effectively distribute the torsion shearing stress. Consequently, a connection portion between the driving end of the screwdriver bit and the locking member may seriously shake such that both have worse fitting to rapidly wear the driving end.

Accordingly, to overcome the foregoing shortcomings, the inventor(s) of the present invention based on years of experience in the related field to conduct extensive researches and experiments for the screwdriver bit structure with the auxiliary sheath.

### SUMMARY OF THE INVENTION

A primary objective of the present invention is to provide a screwdriver bit structure capable of generating a feedback active force while bearing a torsion shearing stress so that the torsion shearing stress then is guided back to a locking member to reduce the torsion shearing stress, and the connection motion between the screwdriver bit and the locking member can be stably obtained to effectively reduce the consumption loss for a driving section at a front of the screwdriver bit.

To achieve the foregoing objective, the screwdriver bit structure provided by the present invention comprises a connection section, a driving section and a neck reducing section between the connection section and the driving section.

The connection section is designed as a polygonal cylinder that is mainly provided for combining a screwdriver bar or a pneumatic tool. A plurality of arc grooves is circularly disposed to a central axis of a front of the driving section to form an operating end for embedding with the locking member. The locking member is a screw with different types of embedding grooves. The front of the operating end is provided with an effective working section to incorporate the total length of the screwdriver bit. The characteristic of the invention is that a plurality of arc grooves is circularly disposed to a front of the driving section. A reinforcement section is preset between one end of each arc groove and a relative bottom edge of the driving section. An external diameter of a maximum cross-section is greater than a total length of the neck reducing section. A diameter of the neck reducing section is greater than or equal to a total length of the effective working section. In addition, an upper tapering transition is disposed between the neck reducing section and the driving section. A lower tapering transition is disposed between the neck reducing section and the connection section. An included angle formed by the upper tapering transition and a relatively horizontal line is smaller than an included angle formed by the lower tapering transition and a relatively horizontal line. Accordingly, after the screwdriver bit structure driven by an electric tool with high rotational speed generates high torsion to drive the locking member to reach a tightening state, generated torsion shearing stress is conducted to the neck reducing section through the upper tapering transition. A portion of the torsion shearing stress then is conducted to the connection section through the lower tapering transition. Another portion of the torsion shearing stress is used to improve the torsion deformation value and fed back to the locking member to have more stable operation, thereby effectively decreasing the consumption loss of the screwdriver bit.

### BRIEF DESCRIPTION OF THE DRAWINGS

FIG. 1 is a front view drawing illustrating a structure according to a preferred embodiment of the present invention;

FIG. 2 is a partial enlarged drawing of a front view illustrating a structure according to a preferred embodiment of the present invention;

FIG. 3 is an A-A cross-sectional drawing according to FIG. 2; and

FIG. 4 is a curve diagram of torsion deformation illustrating the structure according to the present invention;

### DETAILED DESCRIPTION OF THE PREFERRED EMBODIMENTS

Other features and advantages of the present invention will become apparent from the following description of the invention which refers to the accompanying drawings.

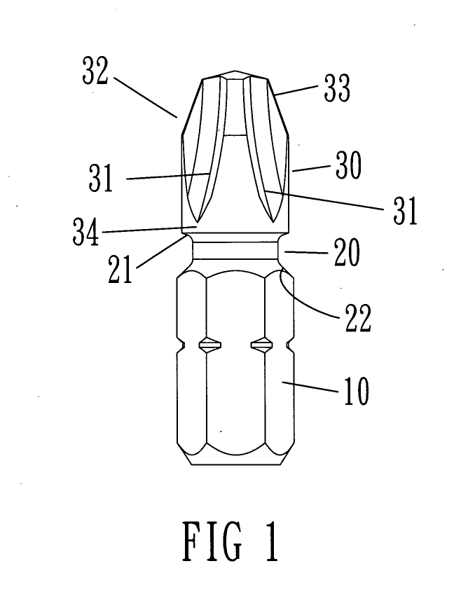

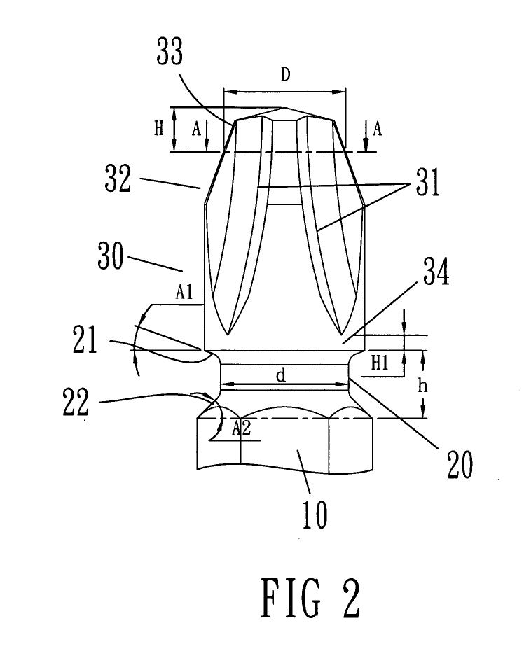

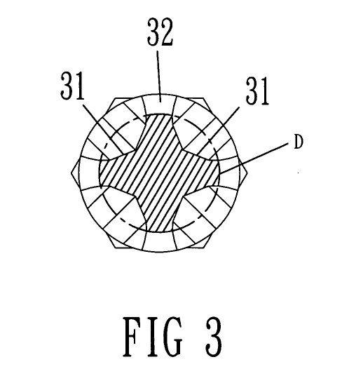

First, please refer to FIG. 1 to FIG. 3, a screwdriver bit structure is shown according to a preferred embodiment of the present invention. A screwdriver bit structure is a bar and composed of a connection section 10, a neck reducing section 20 and a driving section 30.

The connection section 10 is designed as a polygonal cylinder and mainly provided for combining a screwdriver bar (not shown in the figure) or a pneumatic tool (not shown in the figure).

The neck reducing section 20 is disposed between the connection section 10 and the driving section 30 and formed by the same bar.

A plurality of arc grooves 31 is circularly disposed to a central axis of a front of the driving section 30 and processed to form an operating end 32 capable of embedding with a locking member (not shown in the figure). The locking member having different types of embedded grooves is a screw. In the embodiment, a crisscross operating end 32 is shown. a front of the operating end 32 is provided with a standard effective working section 33 to incorporate a total length of the screwdriver bit. The length of the effective working section 33 is marked as “H” shown in the figure. The characteristic of the structure is that a plurality of arc grooves 31 is circularly disposed to a front of the driving section 30. A reinforcement section 34 is preset between an end of each arc groove 31 and a relative bottom edge of the driving section 30. A distance of the reinforcement section 34 is marked as “H1” shown in the figure. In addition, an external diameter (which is marked as “D” shown in the figure) of a maximum cross-section of the effective working section 33 is greater than a total length (which is marked as “h” as shown in the figure) of the neck reducing section 20. A diameter (which is marked as “d” shown in the figure) of the neck reducing section 20 is greater than or equal to the length H of the effective working section 33.

Moreover, an upper tapering transition 21 is disposed between the neck reducing section 20 and the driving section 30. A lower tapering transition 22 is disposed between the neck reducing section 20 and the connection section 10. An included angle A1 formed by the upper tapering transition 21 and a relatively horizontal line is smaller than an included angle A2 formed by the lower tapering transition 22 and a relatively horizontal line.

After the screwdriver bit assembled by the foregoing features is driven by an electric tool with high rotational speed to generate high torsion to tighten the locking member, a generated torsion shearing stress is conducted to the neck reducing section 30 through the upper tapering transition 21. A portion of the torsion shearing stress then is conducted to the connection section 10 through the lower tapering transition 22. Another portion of the torsion shearing stress is fed back to the locking member from the upper tapering transition 21 via the operating end 32 to obtain more stable operation, thereby effectively reducing the consumption loss of the screwdriver bit.

According to the computation of the torsion shearing stress, the torsion shearing stress is in inverse proportion to polar moment of inertia and in direct proportion to a radius. The polar moment of inertia is an area value that multiplies by the radius to the power two. Therefore, the polar moment of inertia is relatively increased when the radius is increased. The contribution of the radius to the torsion shearing stress is smaller than the polar moment of inertia. Under the condition of the same torsion, if the radius is smaller, the torsion shearing stress generated by the smaller radius is larger. The invention does not only dispose the working section 30 with the smallest cross-section area to the driving section 30, but also installs another neck reducing section 20 with a smaller cross-section area additionally. The torsion deformation value is improved by the neck reducing section 20 while facing the high rotational speed and high torsion. Further, the length of the neck reducing section 20 is smaller than the external diameter of the maximum cross-section of the effective working section 33. The diameter of the neck reducing section 20 is greater than or equal to the length H of the effective working section 33 to have the efficacy of improving the structural strength. When the torsion is increased, a feedback force is generated, and a portion of torsion is transferred to the locking member to timely reduce the torsion without damaging the screwdriver bit.

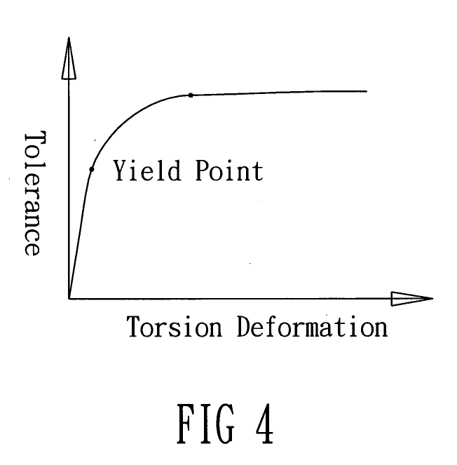

As shown in FIG. 4, when the invention is received the torsion, the torsion deformation is increased. The generated torsion deformation shown in the curve diagram enters a restored elastically deformation field before the torsion reaches a yield point. After the torsion exceeds in the yield point, the torsion deformation enters a plastic deformation field. After reaching the yield point, the torque deformation curve with respect to the neck reducing section 20 utilized by invention is gradually extended and continuously retained in the extended plastic deformation field so that the working section 33 is not damaged.

Although the features and advantages of the embodiments according to the preferred invention are disclosed, it is not limited to the embodiments described above, but encompasses any and all modifications and changes within the spirit and scope of the following claims.

What is claimed is:

1. A screwdriver bit structure comprising:
a connection section, a neck reducing section extended from one end of the connection section, a driving section extended from the neck reducing section, an operating end disposed in a front of the driving section, an effective working section disposed in a front of the operating end; the characterized in that an external diameter of a maximum cross-section of the effective working section is greater than a length of the neck reducing section, and an external diameter of the neck reducing section is greater than or equal to a length of the working section to achieve the function of strengthening a structure.

2. The screwdriver bit structure as claimed in claim 1, wherein a plurality of arc grooves is circularly disposed to the central axis of the front of the operating end to form the working section, and a reinforcement section is preset between an end of each arc groove and a relative bottom edge of the driving section.

3. The screwdriver bit structure as claimed in claim 1, wherein an upper tapering transition is disposed between the neck reducing section and the driving section, and a lower tapering transition is disposed between the neck reducing section and the connection section.
